(19) United States
(12) Patent Application Publication
(10) Pub. No.: US 2024/0373151 A1
(43) Pub. Date: Nov. 7, 2024

(54) Device, Method and System for Improved UAV Operations Using Continuous Analysis of Telemetry Link Integrity

(71) Applicant: Censys Technologies Corporation, Daytona Beach, FL (US)

(72) Inventors: Tanmay Dilip Naik, Daytona Beach, FL (US); Max Bennett Siege, Port Orange, FL (US)

(21) Appl. No.: 18/576,576

(22) PCT Filed: Jul. 1, 2022
(86) PCT No.: PCT/US2022/073368

§ 371 Date: Jan. 4, 2024

Related U.S. Application Data
(60) Provisional application No. 63/203,027, filed on Jul. 6, 2021.

(51) Int. Cl. H04Q 9/02; G06F 1/14

(52) U.S. Cl. CPC H04Q 9/02; G06F 1/14

(57) ABSTRACT

A device, method, and system for improved command and control functionality of uncrewed aerial vehicle (UAV) operation using continuous analysis of telemetry link integrity is disclosed. Observation, mapping and mission specific data is combined with key performance indicators of a data link from a communications network in real time. Telemetry health data from the UAV is synchronized with data from ground control stations (GCS) and delivered with time stamps to create a log file with data relative to the UAV and the GCS as well as associated link performance; this information enables an operator to alter mission parameters, thereby enhancing flight efficiency and UAV performance. Data generated by the device may be used for optimizing performance of communications network infrastructure, and data generated by the system can be used to map performance and get insight regarding network capabilities and monitor link status for operational performance optimization and certification.

### CROSS-REFERENCE TO RELATED APPLICATIONS

This application claims the benefit of the prior filing date under 35 U.S.C. § 119(e) of U.S. Provisional Application No. 63/203,027, filed on Jul. 6, 2021.

### STATEMENT REGARDING FEDERALLY SPONSORED RESEARCH/DEVELOPMENT

Not applicable.

### REFERENCE TO SEQUENCE LISTING, A TABLE, OR COMPUTER PROGRAM LISTING COMPACT DISC APPENDIX

Not applicable.

### BACKGROUND OF THE INVENTION

The present invention relates to uncrewed aerial vehicle (UAV) operations, and more specifically to optimization of command and control equipment and functionality of UAV devices and systems. Whereas UAVs are comprised of all hardware and software physically connected or stored to the airborne device, UASs include all supporting hardware and software required for safe operations, including a datalink, GCS, cellular infrastructure, and more. By assessing and monitoring information relating to the key performance and operational indicators (KPIs) of a telemetry link transmitted over a cellular network or wireless communication radios in real-time and integrating this information with data from UAS operations, increased flight precision and control can be achieved.

Current technological advances in the use and operation of UASs have shifted operational efficiencies for various tasks such as mapping, utility inspection, intelligence, surveillance, reconnaissance, search and rescue, and similar missions. UASs are increasingly used because of their cost and resource effective approach for such missions. However, the UAVs deployed as part of UASs require effective command and control functionality to be efficient and operate within mission-specific parameters. UAVs need to communicate continuously with the remote pilot in command. As operational capabilities and use cases continue to expand for UAVs, there is an increasing need for real-time monitoring and assessing performance via operational indicators for the telemetry and control link to ensure safe and efficient operations. This expanded monitoring and assessment requires a continuous, thorough, effective, and integrated verification process with the telemetry connections over dependable, established networks, such as cellular, radio, or other wireless networks to enable a UAS, inclusive of the UAV, its GCS, its datalink, and any other supporting equipment or devices to safely operate.

Traditionally, UASs use one or more communication system links to send telemetry data and use command and control links for operations. The continuity and robustness of these links identifies how safe it is to fly the UAV, especially when operating beyond visual line of sight (BVLOS). Typical operation of UASs includes basic monitoring of signal strength. However, there is a need for consideration of and continuous monitoring for ground level and other aerial obstacles that might be encountered, as well as factors that affect communication radio performance, such as vehicles, trees, buildings or other structures, and signaling equipment. While some presently commercialized systems do provide more advanced signal and network data, this data must be downloaded and post-processed, and is generally missing important indicators for determining safety during flight. These existing systems fall short because of the lag time between data capture and processing, and lack of mapping and synchronization. Processed information is needed continuously to allow for immediate diagnostics and performance monitoring. The ability to capture and immediately act on information as it is processed in real-time is an advantage because information can be captured and incorporated to define operational performance that would not otherwise be available post-flight.

With an increase in the number of UASs being operated in the general airspace and an increase in operation of these UASs BVLOS, the requirements for a robust, secure system to diagnose problems as they arise is critical to safe operation. As BVLOS operations increase in number, flights over civilized and populated areas will also increase, and expand beyond remote search and rescue. More complex surveillance and mapping, drone delivery, and other higher risk operations will become more prevalent.

What is needed is equipment and methodology for UAS operations capable of immediate capture, synchronization, and processing of data for assessing and monitoring the key performance and operational indicators of a telemetry link over a cellular network or radio in real-time.

### BRIEF SUMMARY

The disclosed invention provides a new device and method for optimization of UAS command and control functionality utilizing real-time, synchronized information from multiple sources. By using the device according to the method presented, the invention performs mapping and diagnostics of the telemetry link between a UAV and one or more GCS or GCSs (ground control station or stations) by configuring multiple user endpoints (UE's) on the same communication link or network. A telemetry link refers to the pipeline established between one or more transceivers to connect a plurality of user endpoints to enable communications between the UAV and one or more GCSs. A UE is a device connected to a communication network or a link, which the operator uses to interact with other devices on the same network or communication link. The device and methodology disclosed, as part of an integrated system, incorporate indicators and messages between a UAV and one or more GCSs to monitor the status, integrity and reliability of the connection. These messages typically include indicators such as “loss of heartbeat” events. A UAV is programmed to send a heartbeat message to monitor the link, wherein a signal is sent out between the ground station and the vehicle at regular time intervals, typically in the order of multiple times during one second. If there is a loss of heartbeat message for longer than a predefined time, the GCS will declare a “loss of heartbeat messages” warning or error and the UAV will undertake the predefined set of tasks on such losses. Command messages are periodically sent out to the UAV by the control station to send individual control commands or a request for information from the vehicle. Every command message between the UAV and the control station is acknowledged by the system using an acknowledgment message. A timeout occurs if the vehicle does not reply to a command message with an acknowledgment message within a predefined time period where the operator, or remote pilot in command briefly loses active control over the vehicle or the ability to actively retrieve information critical to UAV operation. These performance metrics indicate whether the telemetry link has been broken, but do not provide any information for diagnostics of why the degradation has occurred. In other words, the problem can be identified but not addressed. What is needed is a way to diagnose issues in the telemetry link based on the wireless communication medium and react to or identify and prevent ongoing or future problems of a related nature.

The invention disclosed herein performs mapping and diagnostics of the telemetry health data by capturing telemetry transceiver performance indicators such as RSSI, SINR, percentage packet loss, UAS orientation, and position data from multiple sources and calculates telemetry health via analysis of key performance and operational indicators (KPI's) such as latency as well as uplink and downlink rates to enable in-depth diagnostics for mitigation of identified issues. A computer readable medium storing a set of computer-executable instructions, is configured to aggregate, calculate, and format data related to the KPI's of the telemetry link and generate a time synchronized data set for manual or automatic exportation and use to optimize command and control functionality. This data set is then transmitted through the telemetry transceiver to the GCS and presented to the UAV operator using an interface. The interface may present the data in the form of an array, a two-dimensional geographical heatmap or a two-dimensional graph. The data may also be presented using optical visualization devices such as goggles in an augmented reality or virtual reality format.

In one or more embodiments, the device can be connected to a traditional Line of Sight (LOS) radio receiver which may be used as a telemetry link. The system, including the hardware, software, and methodology or processes, may be configured to gather performance metrics of the radio, including local and remote noise as well as signal strength. These performance indicators are synchronized with other data such as orientation and position from multiple sources as well as telemetry performance data.

It is an object of this invention to improve UAS operational control by enabling expanded, improved UAV command and control functions with the device, method and system disclosed.

It is another object to provide expanded, improved control of UAVs and UASs by providing real time continuous analysis of telemetry link integrity to UAV operators and automated systems.

It is a different object to provide cellular service providers with reliable, three-dimensional data for assessing network health and performance indicia in order to get in depth insight about the network capabilities for operational and safety analysis of UAVs and UASs.

It is a separate object of this invention to provide a system to monitor and characterize the telemetry link and associated telemetry equipment and related functionality for certification by regulatory or industry standards bodies.

It is a further object of this invention to provide an apparatus capable of remote operation for deployment, data logging and communication with and between one or more separate UAS-GCS networks to enable data gathering using multiple sources.

### REFERENCE CHARACTERS USED IN THE DRAWINGS

1. uncrewed aerial vehicle (UAV)
2. ground control station (GCS)
3. telemetry transceiver
4. microcontroller
5. computer readable medium
6. executable instructions
7. antenna
8. flight controller
9. power source
10. real-time clock (RTC)
11. processor
12. sensors
13. peripheral components
14. global positioning system receivers and antenna (GPS)
15. cellular base station
16. modem
17. radio
18. Flight path
19. Interface
20. Operator

### BRIEF DESCRIPTION OF THE DRAWINGS

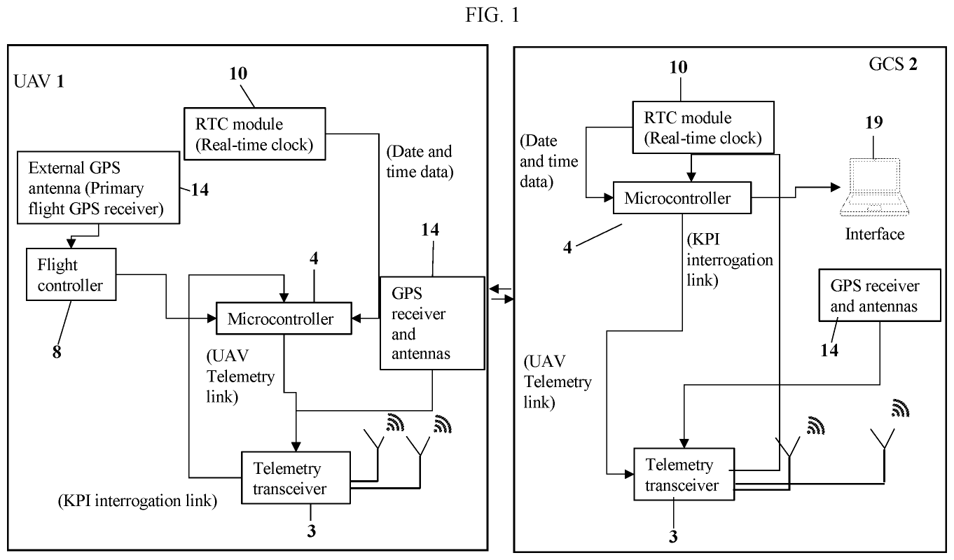

FIG. 1 is a block diagram illustrating device components of an embodiment of the invention;

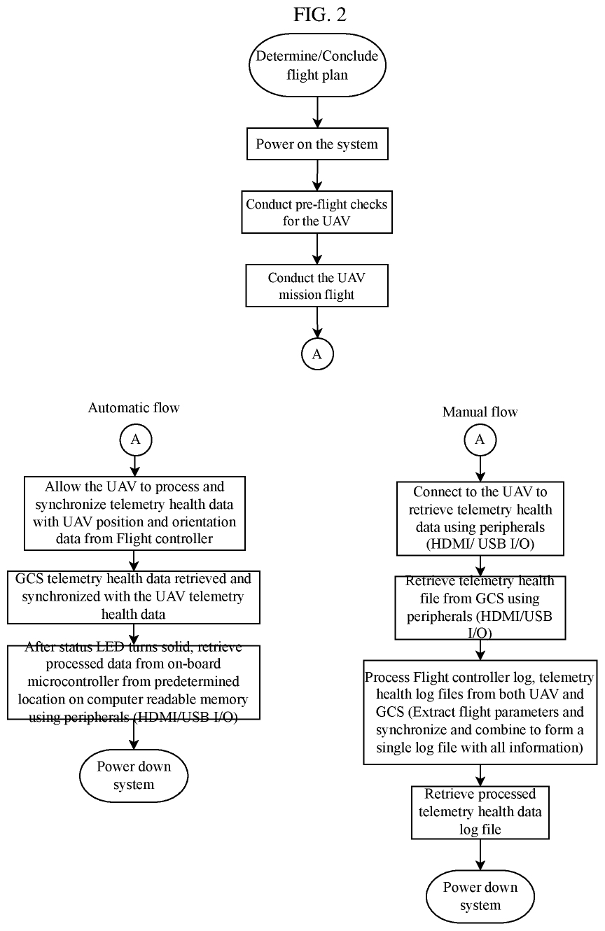

FIG. 2 is a flow diagram illustrating an embodiment of the operational process for continuous analysis of wireless telemetry link integrity; and

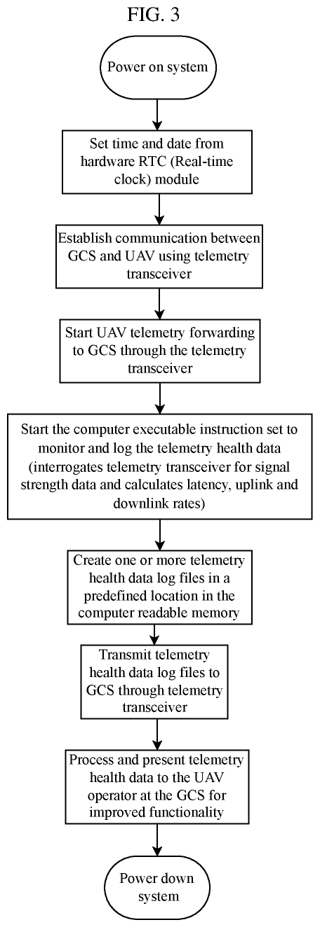

FIG. 3 is a flow diagram of an embodiment of the invention, illustrating the automatic processes that perform data capture and processing.

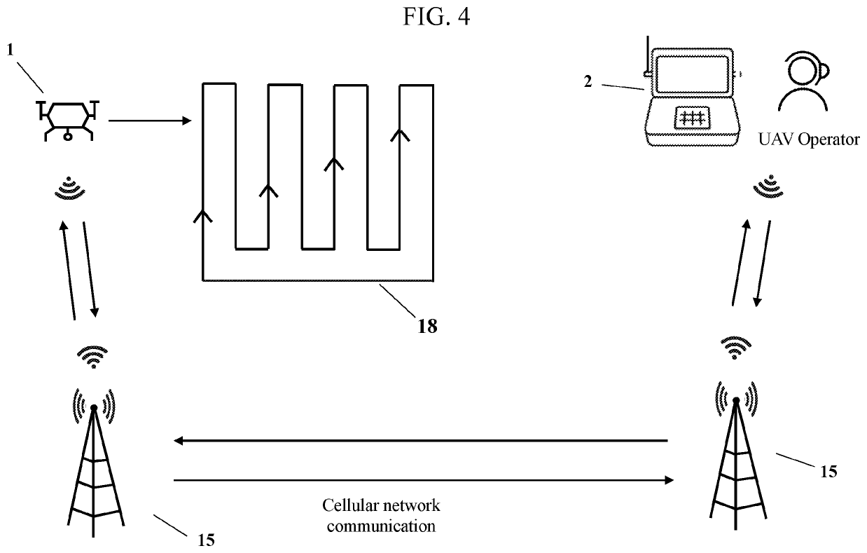

FIG. 4 is an illustration of an operational environment for the invention and the flow of data between the different components of an embodiment of the invention.

### DESCRIPTION OF THE INVENTION

The following description is a representation of the invention and technology presented herein and is intended to describe one or more embodiments of the device. The components described may be enabled as a hardware or a software component. For the scope of this document, telemetry transceiver diagnostics information may be referred to as telemetry health data or network health data.

In FIG. 1, a block diagram illustrating device components of an embodiment of the invention is presented. The invention comprises a device, method of using the device including a computer implemented process, and a system incorporating the device and associated methodology and process.

The device for expanded, improved UAV 1 command and control functions comprises a UAV 1 capable of transmitting and receiving communications related to monitoring and assessment of the KPI's of a telemetry link from a telemetry transceiver 3 in real-time, wherein the telemetry transceiver 3 further comprises payload data and telemetry information pertaining to the UAV 1. The device also includes one or more GCSs 2 capable of commanding and controlling the UAV 1, wherein the GCS 2 is in constant and real-time communication with the UAV 1 during operations through a connection with the UAV 1 using a telemetry transceiver 3. The telemetry transceiver 3 connects the UAV 1 with the GCS 2 and is capable of receiving and transmitting telemetry and payload data to a plurality of UE's to enable communications between the UAV 1 and the GCS 2. The device also includes one or more microcontrollers 4, further comprising a processor 11, a computer readable medium 5 including memory with storage and executable instructions 6, and input and output peripheral components 13 including an interface 19 in communication with one or more microcontrollers 4 capable of connecting with external devices. In a preferred embodiment, stored executable instructions 6 are configured to aggregate, calculate and format data related to the KPI's of the telemetry link and generate a data set for manual or automatic exportation and use to optimize command and control functionality. The preferred embodiment can further include one or more antennas 7; one or more flight controllers 8 connected directly to the telemetry transceiver 3; one or more microcontrollers 4, wherein said microcontrollers 4 are configured to monitor and transfer data between the UAV 1 and the GCS 2 and extract telemetry link KPI data from the telemetry transceiver 3; and a real time clock (RTC) 10 capable of synchronization with RTC 10 components in the GCS 2.

In variations of the device, different cellular, satellite communication based, or wireless radio communication links may be used. Communication between a UAV 1 and the GCS 2 is actuated via the device components. In addition to cellular, satellite, or wireless radio 17 links, the device incorporates various communication components, including a processor 11, one or more global positioning systems (GPS) 14 including receivers and antennas 7, a RTC 10 to maintain the correct time and date for timestamping and synchronizing the gathered data, sensors 12 or sensing elements to gather network data as well as other peripheral components 13 to operate, change configurations and power the system. Peripheral components 13 may include but are not limited to USB input and output devices, visual display units to retrieve and present the telemetry health data to the UAV 1 operator 20 through an interface 19. The interface 19 may be a computer, tablet, phone, or other hand held or mobile device capable of enabling the operator 20 to establish a connection with the device. The GCS 2 may be powered by solar, electric, or other power sources 9, and can operate from the same battery as the UAV 1 or have a separate battery integrated into the system.

With respect to device components, in existing UAV 1 systems designed to test carrier signals, typically the telemetry transceiver 3 is directly connected to the flight controller 8 to enable communication. In the present device and system, the radio 17 may be connected directly to one or more microcontrollers 4. The microcontroller 4 then routes the UAV 1 telemetry data, forwarding it over the telemetry transceiver 3, enabling the connection between the GCS 2 and UAV 1. The one or more microcontrollers 4 monitor the rates at which the UAV 1 and GCS 2 send telemetry, KPI and payload data through the telemetry link in order to provide an accurate measure of the uplink and downlink rates, monitor and log latency data and export this data to assess the health of the telemetry link. The microcontroller 4 monitors the telemetry link for different statistics, including the total amount of data being sent and received and the latency in the telemetry link. The device might also include a secondary link between the telemetry transceiver 3 and the microcontroller 4. It allows the microcontroller 4 to communicate with the telemetry transceiver 3 to extract telemetry health data.

In one or more embodiments, the device can be connected to a telemetry transceiver 3, wherein the telemetry transceiver 3 can be radio frequency (RF) based, cellular, satellite, or point to point (P2P) wireless radio 17 connections, or other technologies that connect the UAV 1 to the GCS 2. When operating with cellular telemetry transceivers 3, the UAV 1 is effectively connected to the GCS 2 via a cellular base station 15 of a cell tower of a cellular network, which can receive and transmit the telemetry signal and associated data to a plurality of nodes or devices, called user endpoints (UE) connected to the same cellular network. The UE's are used with a cellular or radio 17 network to enable communications. When using a cellular network, the cellular network used may be configured in a Mobile Private Network (MPN) configuration or a public network with restricted authorized access. An antenna 7 or sensor-based receiver system may be mounted upon the UAV 1 and used to monitor and log cellular KPI's. This data is then synchronized with time-based orientation and position data. Telemetry performance and UAV 1 operation data, including “command message timeout”, “loss of heartbeat” events and mode of operation of the UAV 1 (Auto, guided, manual, FBW—Fly-By-Wire, etc.) are extracted from the telemetry and dataflash logs (flight stack logs). The orientation data is gathered from the flight controller 8 system and position data is gathered from multiple sources including but not limited to GPS 14 strings $GPGGA and $GPRMC, and barometer readings. A time synchronized data set using GPS 14 time, including information related to the UAV 1 telemetry performance indicators, signal strength from telemetry radios 17 and orientation and position information is generated.

The GCS 2 in a preferred embodiment comprises an interface 19 capable of establishing a connection with the UAV using the telemetry transceiver 3. The interface 19 may be a computer, tablet, phone, hand held or mobile device capable of enabling an operator 20 to establish a connection with a UAV 1. The GCS 2 further comprises a set of controls for commanding and controlling the UAV 1; one or more microcontrollers 4 capable of extracting telemetry link KPI data from the telemetry transceiver 3 and synchronizing the data with UAV 1 telemetry transceiver data and reading the dataset to display the telemetry health data; a connection with payload data including media generated by UAV 1 payload sensors 12; a RTC 10 capable of synchronization with RTC 10 components in the UAV 1.

Similar to the configuration on the UAV 1, the GCS 2 telemetry transceiver 3 is connected to the GCS 2 interface 19 by forwarding the telemetry link though the microcontroller 4 and is effectively integrated with the interface 19 through a microcontroller-based system. This allows configuration of the system using computer executable instructions 6 to implement a process to log and monitor the telemetry health data on either side of the communication link (from the UAV 1 and the GCS 2) in real-time. As a result, log files are created of the UAV 1 as well as the GCS 2 performance containing expanded, synchronized telemetry link diagnostics.

In order to combine these log files generated and to output a single file with the data from both the aforementioned telemetry health data log files (UAV 1 and GCS 2) and position, orientation, mode of operation and telemetry link performance indicators including but not limited to latency and uplink and downlink rates as well as the telemetry and dataflash log synchronized based on the timestamps, the device and system use a computer executed instruction set as a post-processing script. The resulting combined log file may include information from both the UAV 1 and the GCS 2, as well as other system configuration information to identify the aircraft and the components.

Although the microcontroller 4 components are a part of the communication link, in one or more embodiments, one or more microcontrollers 4 may either be embedded into the avionics system or contained as a part of the payload of the UAV 1. The payload may use any physical interface 19 that enables the telemetry transceiver 3 to be integrated with the software protocol used by and compatible with the UAV 1. This physical interface 19 maintains the ability to connect to other peripheral payloads for various types of missions, such as but not limited to cameras, infrared sensors 12, audio recording devices, multi-sensory capture components for AR, VR, and similar apparatus. The physical interface 19 may include connectors for inputs and outputs that include, but are not limited to a voltage-in, ground, transmit, receive, chip select and data input/output to connect the telemetry transceiver 3 housed in the said payload with the aircraft avionics to provide a communication link. One skilled in the art would appreciate that a variety of equipment, mission and payload specific inputs and outputs could be employed and still remain within the disclosure presented.

The antenna 7 for the device can be mounted on the exterior of the UAV 1 in various, mission-appropriate and different orientations and locations based on site, payload and equipment considerations to maximize efficiency and range.

In one or more embodiments, the communication device may be a cellular radio 17 or modem 16. In this case, the UAV 1 may communicate with one or more cellular base stations at any point in time. Cellular base stations 15 are generally configured for maximum coverage at ground level. This system allows for the characterization of the telemetry link over a cellular network and to verify whether the UAV 1 can be operated safely over such a link. This data may be visualized or experienced in a virtual or an augmented reality enabled environment to aid safe operations of the UAS.

When the telemetry transceiver 3 is a cellular radio or modem (hereinafter “modem 16”), the system comprises, but is not limited to, at least one UAV 1 and one or more GCS 2 communicating with one or more microcontrollers 4 that are connected to the modem 16. The microcontroller 4 interrogates the modem 16 using multiple computer executable instructions 6 to collect data including, but not limited to: CELL-ID, PCID (Physical Cell-ID), RSRQ (Reference Signal Received Quality), RSRP (Reference Signal Received Power), RSSI (Received Signal Strength Indicator), SINR (Signal to Interference plus Noise Ratio) and calculates uplink and downlink speed as well as latency based on the cellular (LTE/4G/3G) connection. The computer executable instructions 6 on the computer readable medium 5 also allow logging of GPS data in the form of $GPGGA and $GPRMC streams, which includes but is not limited to latitude, longitude and altitude data, speed in knots as recorded by GPS, true course, satellites in view and a GPS Q indicator. The computer executable instruction set on this microcontroller 4 also provides for extraction of telemetry data such as orientation and position of the UAV 1 (roll, pitch, yaw) as well as command message timeouts and loss of heartbeat events from black box recording and telemetry logs created by the flight controller 8 and the GCS 2 software. This data is synchronized with cellular logs using GPS timestamps. A RTC 10 maintains the correct time on the microcontroller 4 on both the UAV 1 and the GCS 2. This data can be used by cellular service providers to prepare a coverage map based on cellular network health data in multiple dimensions to get in depth insight about the network quality as well as for telemetry for UAV 1 certification purposes.

The UAV 1 of the present invention comprises a flight controller 8 connected directly to a telemetry transceiver 3. In one or more embodiments of the device, the telemetry transceiver 3 may be connected to one or more microcontrollers 4 that monitor the UAV telemetry data and forward it via a communication link to the flight controller 8. One or more secondary microcontrollers 4 may be installed on the GCS 2 to monitor the link and transfer data between the UAV 1 and the GCS 2. The microcontrollers 4 monitor the rates at which the UAV 1 and GCS 2 send data on the telemetry transceiver 3; this provides an accurate measure of the uplink and downlink rates. Due to the nature of operation of a UAV 1, latency is an important factor for the command-and-control link, as it determines the controllability of the UAV 1. The latency is measured by sending a ping message using an active telemetry link and measuring the round-trip time. In a preferred embodiment, one or more microcontrollers 4 monitor the rates at which the UAV 1 and GCS 2 send data on the telemetry transceiver 3 to provide an accurate measure of the uplink and downlink rates. Monitoring and logging the latency data allows the operator 20 to apply this data to real time flight path 18 determination. The flight path 18 is decided based on additional information including but not limited to the area of test and operation, weather and other operational factors to verify the telemetry link as well as the environment to ensure safe operation.

In one or more embodiments of the invention, the device may be configured to transmit telemetry health data using the flight controller 8 telemetry data stream itself. Doing this enables synchronization of the GCS 2 and UAV 1 telemetry health data in real-time. This may be done by incorporating the transmission of the telemetry health data through the same software protocol as the UAV 1 telemetry data. A threshold based on flight tests, combination of the different telemetry link performance parameters and environmental factors is decided to inform the remote operator 20 or pilot in command whether it is safe to continue operating the UAV 1 or if the telemetry link is not safe due to interference and other factors in real-time.

FIG. 2 is a flow diagram illustrating an embodiment of the operational process for continuous analysis of a wireless telemetry link. The invention disclosed provides an improved way to verify the integrity, reliability, robustness and speed of the telemetry link being used during operation of a UAV 1. The wireless telemetry link may be a cellular link, a LOS (line of sight) P2P radio 17 link or other traditionally used wireless links for telemetry between the GCS 2 and the UAV 1. The UAV 1 may have a flight path 18 configured with varying altitudes to map the network data in three dimensions for a deeper understanding of the wireless signal propagation and losses.

The operational process is initiated by defining the location of an operation based on the testing and verification requirements of a particular mission, which includes a flight route, test plan, altitude, and path. Speed, weather, and related operational conditions are checked and recorded, and any required clearance or waivers are secured. At the test site, pre-flight setup and checks are undertaken, which include but are not limited to unboxing and assembly of the UAV 1; installation and securing of the payload; powering up of GCS 2 and UAV 1; and physical observation of system indicators to assure cellular base station tower or telemetry connection with the devices. Once the GCS 2 and UAV 1 have connected to the cellular network or have established connection through the traditional telemetry transceiver 3, connection to the UAV 1 is made using the GCS 2. Physical pre-flight checks are performed. The telemetry link monitoring system boots up automatically. The device is enabled using computer executable instructions 6 to process, synchronize and log data.

The mission is conducted according to a specified flight plan. The aircraft can either fly autonomously or be flown manually as needed. The telemetry link monitoring and logging system is independent of the “RC” or remote radio control.

During operation, the system creates data log files which are used to create a completed and combined telemetry health log file. It generates a telemetry log file, a Dataflash log file (Flight stacks log/Blackbox log), and two telemetry health logs, one recording data from the UAV 1, and the second one from the GCS 2. This provides information related to the signal strength observed after propagation on either side of the system. These log files are retrieved manually or may be set up to be transmitted to a microcontroller 4 automatically in order to synchronize using GPS 14 timestamps. FIG. 2 illustrates the manual and automatic process of operational flow is illustrated in the figure. Once the UAV 1 has completed its mission, it can either be set up to automatically transmit the created telemetry health log file to the GCS 2 through the telemetry transceiver 3 and synchronized with the GCS 2 logs using computer executable instruction sets or the files from the UAV 1 and the GCS 2 can be retrieved manually to be further aggregated, synchronized and formatted as required.

The invention disclosed includes a method for assessing and monitoring the key performance and operational indicators of a telemetry link over a cellular network or wireless communication radio in real-time. The method comprises the steps of: determining the flight plan for the mission; powering on the system; conducting UAV 1 pre-flight checks; conducting the UAV 1 mission flight, wherein conducting the mission flight includes at least continuous monitoring for ground level and other aerial obstacles that might be encountered, ongoing identification and analysis of factors that affect communication radio 17 performance, such as vehicles, trees, buildings or other structures, and signaling equipment, and either manually or automatically processing and synchronizing telemetry health data and presenting it via an interface 19 to a remote operator 20. When automatically processing and synchronizing telemetry health data, the method further comprises steps including UAS processing and synchronization of telemetry health data with UAV 1 position and orientation data from the flight controller 8; retrieval and synchronization of GCS 2 telemetry health data with the UAV 1 position and orientation data; retrieval of processed telemetry health data from the microcontroller 4; and presented to an operator 20 at an interface 19; and powering down the system. The manually operated method separately comprises a series of steps, the steps include connecting the UAV 1 to the UAS to retrieve UAV 1 telemetry health data using peripheral components 13; retrieving GCS 2 telemetry health data from the GCS 2 using peripheral components 13; processing flight controller 8 log information to generate telemetry health log files from both the UAV 1 and GCS 2; and extracting flight parameters and synchronizing and combining GCS 2 and UAV 1 log files to create a single integrated data file; and presenting the integrated data file to the operator 20 for improved and expanded UAV 1 control.

FIG. 3 is a flow diagram of an embodiment of the invention, illustrating the processes that perform data capture and processing. The system is powered on, and time and date stamps are established using a real-time clock (RTC) 10, which may be configured as a module and use a separate internal battery to maintain the current time. When powered on, the flight controller 8 on the UAS module is connected to the microcontroller 4. The UAV 1 telemetry link is sent first to the microcontroller 4, which allows the microcontroller 4 to monitor and log the UAV 1 telemetry data. This telemetry data is then forwarded to the GCS 2 with the help of the telemetry transceiver 3, which are connected to the microcontrollers 4 on the GCS 2 and the UAV 1. In this embodiment, the telemetry link uses MAVlink protocol and this MAVlink stream is forwarded to the GCS 2. The microcontroller 4 on the GCS 2 is then used to forward the UAV 1 telemetry link over to an interface 19 and the UAV 1 is connected to and controlled using a GCS 2. The telemetry transceiver 3 is connected to the on-board microcontroller 4 using either a single communication link that can be used to forward the telemetry link and monitor telemetry health data or using a separate wired or wireless link to interrogate the transceiver for the necessary KPIs.

In a preferred embodiment of the invention, automatic systems are employed for establishing various connections. The telemetry transceiver 3 is connected to the microcontroller 4 using either a single communication link that can be used to forward the UAV 1 telemetry link and monitor telemetry health data or using a separate link to interrogate the telemetry transceiver 3 for the necessary KPIs. As the system boots, there are various systems which are set to execute. Once the user powers on the aircraft, the microcontroller 4 boots up. On bootup, computer executable instructions 6 are scheduled to run that sets the date and time from a RTC 10 module. The module is equipped with an auxiliary power source 9 such as a battery and keeps a track of the time between boot ups.

A computer executable instruction set that opens a port is executed to make sure the GCS 2 can communicate with the UAV 1 to monitor latency. Once the UAV 1 has booted up, it will start sending telemetry data to the microcontroller 4 and wait for a heartbeat message to initiate connection. One or more sets of computer executable instruction sets that accept the telemetry link, log and forward it over to the telemetry transceiver 3 is initiated. A computer executable instruction set that interrogates the telemetry transceiver 3 to log and monitor the signal strength as well as calculate and log the latency, uplink and downlink rates is executed. This generates one or more log files in a predefined location in the computer readable memory. These log files are then transmitted over to the GCS 2 through the telemetry transceivers 3 to be synchronized and aggregated with the GCS logs using computer executable instructions 6 to generate one telemetry health data log file. This file is presented to the UAV 1 operator 20 at the GCS 2 for improved functionality.

FIG. 4 is an illustration of an operational environment for the invention and the flow of data between the different components of an embodiment of the invention. In this embodiment, the device is used for mapping cellular network health, which may then be used for various applications such as flight planning for the UAV 1 or provided to cellular service providers for optimization of network performance. The device is equipped with a cellular telemetry transceiver 3. The flight path 18 may be configured in a particular pattern, with multiple altitude variations for a 3-dimensional map of the performance indicators and with various turning radii and bank angles for a better understanding of orientations and its effects on the telemetry link. FIG. 4 depicts an example of a pattern that the UAV 1 may be configured to fly in; any mission-specific flight pattern or array can be used and would be considered within the scope of this disclosure. In an embodiment of the device, it may be equipped with more than one cellular telemetry transceiver 3 to map more than one network at the same time. The UAV 1 cellular telemetry transceiver 3 and the GCS 2 telemetry transceiver 3 are connected wirelessly to cellular base station 15 towers, and the quality of these links is mapped by interrogating the cellular telemetry transceivers 3 using computer executable instructions 6 in real-time. The UAV 1, the GCS 2, the telemetry transceiver 3, the one or more microcontrollers 4, and the computer readable medium 5 storing a set of computer-executable instructions 6 can be integrated with cellular base stations 15 to provide cellular service providers with reliable, three-dimensional data for assessing network health and performance indicia in order to get detailed information about the network capabilities for operational and safety analysis of UASs. With this information, the UAV 1 operator 20 is empowered with real time information and thereby enabled to make informed mission safety decisions in case the telemetry link does not perform optimally. The information can also be used monitor and characterize the telemetry link and associated telemetry equipment and related functionality for certification by regulatory or industry standards bodies.

In addition to the hardware components of the system, the invention further comprises a computer assisted process for synchronization of cellular data from UAS, GCS 2 and telemetry data as logged and delivered to the GCS 2 with GPS 14 time stamps to create a log file with position, orientation and navigation data of the UAV 1 and the GCS 2 as well as their telemetry link performance data (cellular data, signal strength data). The system's microcontroller 4 calculates the total uplink and downlink data transferred, the rates and the latency observed between the 2 systems in the telemetry link as observed on either side. It also provides the speed of the UAV 1 from multiple sources such as GPS 14 data and calculations from north, east and down velocities extracted from the flight telemetry. The system's software also provides altitude data from multiple sources such as GPS 14 data from multiple receivers (latitude, longitude, altitude, number of satellites in view, etc) as well as from the barometer. It is further capable of time synchronizing the changes in UAV 1 operation MODE (Auto, Guided, loiter, FBW or Fly-By-Wire), sourced from the telemetry files. Once processing functions have been completed, the microcontroller 4 delivers information to an interface 19, enabling an operator 20 or controller at the GCS 2 to modify flight path 18 or alter other mission parameters, thereby enhancing flight efficiency and UAV 1 performance. Data generated by the system can also be used by cellular service providers to map performance and get insight regarding network capabilities and monitor link status for operational certification.

The steps for implementing the process using computer executed instructions configured to improve UAV 1 performance and control comprise, generally, the steps of: establishing a connection between the UAV 1 and one or more GCSs 2 to send and receive UAV 1 telemetry data command and control the UAV 1; calculating the latency of the telemetry link by sending a ping message over the telemetry link and observing the round trip time; calculating the uplink and downlink rates by observing the total data transmitted and received by the microcontroller 4; gathering performance indicators from the telemetry transceiver 3 by interrogating the telemetry transceiver 3; storing gathered telemetry health data in a predefined location in the computer readable medium 5; transmitting the telemetry health data from the UAV 1 to the GCS 2 through the telemetry transceiver 3; synchronizing the telemetry health data from the UAV 1 and the GCS 2 using GPS 14 timestamps, and aggregating the synchronized telemetry health data with position and orientation information from GPS 14 and UAV 1 telemetry logs to generate a combined telemetry health data log file; and presenting the combined telemetry health data log file to the UAV 1 operator 20 for improved functionality.

The methodology disclosed herein additionally provides an improved method for generating a coverage map for cellular service providers. The method includes the capture and presentation of lag time measured between transmission and receipt of data along the telemetry link, and provides for continuously processed data to be used for immediate diagnostics and performance monitoring in order to capture and immediately act on information as it is processed in real-time.

The invention includes a system for improved performance and control of UAS 1 functionality. The system comprises the device operated according to the method described, and incorporates a computer implemented process to improve command and control capability of an operator 20 and enable integration with cellular base stations 15 to provide cellular service providers with reliable, three-dimensional data for assessing network health and performance indicia in order to get detailed information about the network capabilities for operational and safety analysis of UASs.

We claim:

1. A device for expanded, improved UAV command and control functions, the device comprising:
a. an uncrewed aerial vehicle (UAV) capable of transmitting and receiving communications related to monitoring and assessment of the key performance and operational indicators (KPI's) of a telemetry link from a telemetry transceiver in real-time, wherein the telemetry transceiver further comprises payload data and telemetry information pertaining to the UAV;
b. one or more ground control stations (GCS) capable of commanding and controlling the UAV, wherein the GCS is in constant and real-time communication with the UAV during operations through a connection with the UAV using a telemetry transceiver;
c. a telemetry transceiver connecting the UAV with the GCS and capable of receiving and transmitting telemetry and payload data to a plurality of user endpoints (UE's) to enable communications between the UAV and the GCS;
d. one or more microcontrollers, further comprising a processor, a computer readable memory with storage and input and output peripheral components to view data from the one or more microcontrollers with external devices; and
e. a computer readable medium storing a set of computer-executable instructions, the stored computer-executable instructions configured to aggregate, calculate and format data related to the KPI's of the telemetry link and generate a data set for manual or automatic exportation and use to optimize command and control functionality.

2. The device of claim 1 wherein the telemetry transceiver is a radio frequency (RF), cellular, satellite or radio-based transceiver or modem, and wherein the telemetry transceiver is used to establish a telemetry link between the UAV and GCS and transmit and receive UAV telemetry data, telemetry link KPI data and payload data.

3. The device of claim 1, wherein the UAV further comprises:
a. one or more antennas;
b. one or more flight controllers connected directly to the telemetry transceiver;
c. the one or more microcontrollers, wherein said microcontrollers are configured to monitor and transfer data between the UAV and the GCS and extract telemetry link KPI data from the telemetry transceiver; and
d. a real time clock (RTC) capable of synchronization with RTC components in the GCS.

4. The device of claim 3 wherein the one or more microcontrollers monitor the rates at which the UAV and GCS send telemetry, KPI and payload data through the telemetry link in order to provide an accurate measure of the uplink and downlink rates, monitor and log latency data and export this data to assess the health of the telemetry link.

5. The device of claim 1, wherein the GCS further comprises:
a. an interface capable of establishing a connection with the UAV using the telemetry transceiver and further comprising a set of controls for commanding and controlling the UAV;
b. one or more microcontrollers, capable of extracting telemetry link KPI data from the telemetry transceiver, synchronizing the data with UAV telemetry transceiver data and reading the dataset to display the telemetry health data
c. a connection with payload data including media generated by UAV payload sensor components; and
d. a RTC capable of synchronization with RTC components in the UAV.

6. The device of claim 5 where the interface is a computer, tablet, phone, hand held or mobile device capable of enabling the operator to establish a connection with a UAV.

7. The device of claim 1 wherein the UAV, the one or more GCSs, the telemetry receiver, the one or more microcontrollers, and the computer readable medium storing a set of computer-executable instructions are integrated with cellular base stations to provide cellular service providers with reliable, three-dimensional data for assessing network health and performance indicia in order to get detailed information about the network capabilities for operational and safety analysis of UASs.

8. The device of claim 1, wherein the computer executable instructions enable a computer implemented process to capture telemetry health data and manually aggregate, synchronize, and export the information in required format.

9. The device of claim 1, wherein the computer executable instructions enable a computer implemented process to capture telemetry health data and automatically transmit this data to the GCS through the telemetry transceivers to synchronize, aggregate and export UAV and GCS telemetry health data along with position and orientation data.

10. The device of claim 1, wherein the computer executable instructions are stored in the computer readable medium and extracted and executed during operation enabling monitoring of the UAV telemetry link and the telemetry health data in real time; wherein the extracted telemetry health information is stored in the form of log files in a predefined location and accessed by an operator to capture and immediately act on UAV operational information as it is processed in real-time to improve UAV command and control.

11. The device of claim 1, wherein the computer executable instructions enable a computer implemented process to capture telemetry health data and automatically transmit this data to the GCS through the telemetry transceivers to synchronize, aggregate and export UAV and GCS telemetry health data along with position and orientation data.

12. The device of claim 1, wherein the UAV, the one or more CGS's, the telemetry receiver, the one or more microcontrollers, and a computer readable medium storing a set of computer-executable instructions monitor and characterize the telemetry link and associated telemetry equipment and related functionality for certification by regulatory or industry standards bodies.

13. A method for assessing and monitoring the key performance and operational indicators of a telemetry link over a cellular network or wireless communication radio in real-time using the device of claim 1, the method comprising the steps of:
a. determining a flight plan for the mission;
b. powering on the device;
c. conducting UAV pre-flight checks;
d. conducting the UAV mission flight, wherein conducting the mission flight includes at least:
i. continuous monitoring for ground level and aerial obstacles;
ii. ongoing identification and analysis of factors that affect communication radio performance, including vehicles, trees, buildings, structures, and signaling equipment; and
iii. either manually or automatically processing and synchronizing telemetry health data and presenting it via an interface to a remote operator.

14. The method of claim 13, wherein the method enables improved and expanded control of a UAV, and wherein the method of automatically processing and synchronizing telemetry health data further comprises the following steps:
a. the UAS processes and synchronizes telemetry health data with UAV position and orientation data from a flight controller;
b. GCS telemetry health data is retrieved and synchronized with the UAV position and orientation data;
c. processed telemetry health data is retrieved from the microcontroller; and presented to an operator at an interface; and
d. the device is powered down.

15. The method of claim 13, wherein the method enables improved and expanded control of a UAV, and wherein the method of manually processing and synchronizing telemetry health data further comprises the following steps:
a. connecting the UAV to the UAS to retrieve UAV telemetry health data using peripheral components;
b. retrieving GCS telemetry health data from the GCS using peripherals;
c. processing flight controller log information to generate telemetry health log files from both UAV and GCS;
d. extracting flight parameters and synchronizing and combining GCS and UAV log files to create a single integrated data file; and
e. presenting the integrated data file to the operator for improved and expanded UV control.

16. The method of claim 13, additionally providing an improved method for generating a coverage map for cellular service providers using the device of claim 1, wherein the method further includes the capture and presentation of lag time measured between the transmission and receipt of data along the telemetry link, and provides for continuously processed data to be used for immediate diagnostics and performance monitoring in order to capture and immediately act on information as it is processed in real-time.

17. The method of claim 13, further comprising a computer assisted process for synchronization of cellular data from UAS, GCS as well as telemetry data as logged on the UAS and control station using GPS time stamps to create a log file with position, orientation and navigation data of the UAS and the GCS as well as their telemetry link performance data including cellular data and signal strength data, wherein the method additionally provides improved coverage maps of cellular service and improved operational performance of a UAV.

18. A computer implemented process executed using computer implemented instructions configured to improve UAV performance and control, the process comprising the steps of:
a. establishing a connection between the UAV and one or more GCSs to send and receive UAV telemetry data command and control the UAV;
b. calculating the latency of the telemetry link by sending a ping message over the telemetry link and observing the round trip time;
c. calculating the uplink and downlink rates by observing the total data transmitted and received by the microcontroller;
d. gathering performance indicators from the telemetry transceiver by interrogating the telemetry transceiver;
e. storing gathered telemetry health data in a predefined location in the computer readable memory;
transmitting the telemetry health data from the UAV to the GCS through the telemetry transceiver;
f. synchronizing the telemetry health data from the UAV and the GCS using GPS timestamps, and aggregating the synchronized telemetry health data with position and orientation information from GPS and UAV telemetry logs to generate a combined telemetry health data log file; and
g. presenting the combined telemetry health data log file to the UAV operator for improved functionality.
